(19) United States
(12) Patent Application Publication
(10) Pub. No.: US 2026/0283233 A1
(43) Pub. Date: Sep. 24, 2026

(54) AEROSOL-GENERATING DEVICE WITH AIRFLOW CONTROL VALVE

(71) Applicant: Philip Morris Products S.A., Neuchatel (CH)

(72) Inventors: Rui Nuno Rodrigues Alves BATISTA, Morges (CH); Valerio OLIANA, Pully (CH)

(73) Assignee: Philip Morris Products S.A., Neuchatel (CH)

(21) Appl. No.: 19/477,529

(22) PCT Filed: Apr. 19, 2024
(86) PCT No.: PCT/EP2024/060702

§ 371 Date: Oct. 22, 2025

(30) Foreign Application Priority Data
Apr. 28, 2023 (EP) 23170701.9

(51) Int. Cl. A24F 40/30; A24F 40/465; A24F 40/485; A24F 40/50; H05B 6/36

(52) U.S. Cl. CPC A24F 40/30; A24F 40/465; A24F 40/485; A24F 40/50; H05B 6/36

(57) ABSTRACT

An aerosol-generating device is provided, including: a main cavity to receive a main article having a main aerosol-forming substrate; a main airflow channel extending from a main air inlet to an air outlet via the cavity and including a main inlet channel extending from the air inlet to a cavity inlet, and an air outlet channel extending from a main cavity outlet to the air outlet; and a main cavity outlet valve assembly including a gate valve movable between closed and open positions, and/or a main cavity inlet valve assembly including a gate valve movable between closed and open positions.

The present invention relates to an aerosol-generating device. The present invention further relates to an aerosol-generating system.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. It is also known to use aerosol-forming substrates and aerosol-generating articles having other shapes, for example cuboid or sheet-like shapes, for insertion into the device cavity. It is also known to provide aerosol-generating devices with an enlarged cavity capable of receiving multiple aerosol-generating articles to, for example, allow for a user to combine multiple flavours. A heating element may be arranged in or around the heating chamber for heating the aerosol-forming substrate once the aerosol-generating article is inserted into the heating chamber of the aerosol-generating device.

It would be desirable to provide an aerosol-generating device with improved aerosol-delivery. It would be desirable to provide an aerosol-generating device compatible with diverse aerosol-forming substrates. It would be desirable to provide an aerosol-generating device with an improved aerosol-delivery for diverse aerosol-forming substrates. It would be desirable to provide an aerosol-generating device with an improved aerosol-delivery for diverse aerosol-forming substrates when being heated simultaneously. It would be desirable to provide an aerosol-generating device with an airflow control management. It would be desirable to provide an aerosol-generating device with an improved aerosol-delivery management. It would be desirable to provide an aerosol-generating device with an individualised aerosol-delivery management for diverse aerosol-forming substrates. It would be desirable to provide an aerosol-generating device which avoids or reduces contamination of an inner channel of the device. It would be desirable to provide an aerosol-generating device with customization possibilities. It would be desirable to provide an aerosol-generating device that allows independent and simultaneous use of multiple aerosol-forming substrates. It would be desirable to provide an aerosol-generating device with a compact design.

According to an embodiment of the invention there is provided an aerosol-generating device. The aerosol-generating device may comprise a main cavity arranged for receiving a main article. The main article may comprise a main aerosol-forming substrate. The aerosol-generating device may comprise a main airflow channel extending from a main air inlet to an air outlet via the main cavity. The main airflow channel may comprise a main inlet channel extending from the main air inlet to a main cavity inlet. The main airflow channel may comprise an air outlet channel extending from a main cavity outlet to the air outlet. The aerosol-generating device may comprise a main cavity outlet valve assembly. The main cavity outlet valve assembly may comprise a gate valve. The gate valve may be movable between a closed position and an open position. In the closed position, the gate valve may be closing the main cavity outlet. In the open position, the main cavity may be fluidly connected to the air outlet.

According to an embodiment of the invention there is provided an aerosol-generating device. The aerosol-generating device comprises a main cavity arranged for receiving a main article. The main article comprises a main aerosol-forming substrate. The aerosol-generating device comprises a main airflow channel extending from a main air inlet to an air outlet via the main cavity. The main airflow channel comprises a main inlet channel extending from the main air inlet to a main cavity inlet. The main airflow channel comprises an air outlet channel extending from a main cavity outlet to the air outlet. The aerosol-generating device comprises a main cavity outlet valve assembly. The main cavity outlet valve assembly comprises a gate valve. The gate valve is movable between a closed position and an open position. In the closed position, the gate valve is closing the main cavity outlet. In the open position, the main cavity is fluidly connected to the air outlet.

An aerosol-generating device with improved aerosol-delivery may be provided. An aerosol-generating device which is compatible with diverse aerosol-forming substrates or articles may be provided. An aerosol-generating device with an improved aerosol-delivery for diverse aerosol-forming substrates or articles may be provided. An aerosol-generating device with an improved aerosol-delivery for diverse aerosol-forming substrates or articles when being heated simultaneously may be provided. An aerosol-generating device with an airflow control management may be provided. An aerosol-generating device with an improved aerosol-delivery management may be provided. An aerosol-generating device with an individualised aerosol-delivery management for diverse aerosol-forming substrates or articles may be provided. An aerosol-generating device which avoids or reduces contamination of an inner channel of the device may be provided. An aerosol-generating device with customization possibilities may be provided. An aerosol-generating device that allows independent and simultaneous use of multiple aerosol-forming substrates or articles may be provided. An aerosol-generating device with a compact design may be provided.

The gate valve of the main cavity outlet valve assembly may hermetically seal the main cavity outlet in the closed position.

The gate valve of the main cavity outlet valve assembly may be arranged in the main cavity. The gate valve of the main cavity outlet valve assembly may be configured for being pushed by the main article from the closed position into the open position upon insertion of the main article into the main cavity.

The main cavity outlet valve assembly may comprise a compressible element connected to the gate valve. The main cavity outlet valve assembly may be configured such that the compressible element is in a relaxed configuration when the gate valve is in the closed position.

The aerosol-generating device may comprise a main cavity inlet valve assembly comprising a gate valve. The gate valve of the main cavity inlet valve assembly may be movable between a closed position and an open position, wherein, in the closed position, the gate valve is closing the main cavity inlet, and wherein, in the open position, the main cavity is fluidly connected to the main air inlet. The gate valve of the main cavity inlet valve assembly may hermetically seal the main cavity inlet in the closed position. The gate valve of the main cavity inlet valve assembly may be arranged in the main cavity.

The gate valve of the main cavity inlet valve assembly may be configured for being pushed by the main article from the closed position into the open position upon insertion of the main article into the main cavity. The gate valve of the main cavity inlet valve assembly may be configured for being pushed by the main article from the closed position into the open position upon insertion of the main article into the main cavity, such that the gate valve of the main cavity inlet valve assembly and the gate valve of the main cavity outlet valve assembly can both be pushed by the main article.

The gate valve of the main cavity inlet valve assembly and the gate valve of the main cavity outlet valve assembly may be configured for being both pushed by the main article from the closed position into the open position upon insertion of the main article into the main cavity. The gate valve of the main cavity inlet valve assembly and the gate valve of the main cavity outlet valve assembly may be configured for being both pushed simultaneously by the main article from the closed position into the open position upon insertion of the main article into the main cavity.

The main cavity inlet valve assembly may comprise a compressible element connected to the gate valve. The main cavity inlet valve assembly may be configured such that the compressible element is in a relaxed configuration when the gate valve is in the closed position.

As used herein, the term “compressible element” may refer to a deformable element that can change between a compressed configuration and a relaxed configuration. The compressible element may be a spring element. The spring element may be a helical spring. The spring element may be a planar spring. The compressible element may be formed from a compressible material. The compressible material may be an elastomer.

The aerosol-generating device may comprise a main heating element configured for heating the main article received in the main cavity. The main heating element may be any kind of heating element known to those skilled in the art. The main heating element may be any kind of heating element as described herein.

The main heating element may be an inductive heating element. The main heating element may comprise at least one inductor coil. The at least one inductor coil may be planar. The main heating element may comprise at least one planar inductor coil and at least one planar susceptor element. The susceptor element may be part of the aerosol-generating device. The susceptor element may be part of the main article.

The main cavity may comprise a main cavity opening for insertion of the main aerosol-forming substrate.

The aerosol-generating device may comprise a main axis extending between a proximal end and a distal end of the device. The main cavity opening may be arranged in a lateral sidewall of the device such that the main article may be inserted into the main cavity via the main cavity opening along an insertion direction, the insertion direction being substantially perpendicular to the main axis. The proximal end may comprise a mouthpiece.

The aerosol-generating device may comprise a sealing element arranged in proximity to the main cavity opening. The sealing element may assist in establishing an air-tight connection between the main article and the main cavity opening when the main article is inserted into the main cavity.

The sealing element may be arranged on an outer sidewall of the aerosol-generating device. The sealing element may be arranged to surround the main cavity opening.

As used herein, the terms “sealing”, “sealed”, “closing”, and “closed” are not limited to 100 percent airtight configurations, only. The terms may also cover situations where an opening is substantially sealed or closed. For example, in the sealed or closed configuration a cross-sectional area of an opening may be reduced by at least 90 percent, preferably by at least 95 percent, in comparison to the unsealed or open configuration. Sealing elements described herein may comprise an elastic material. The elastic material may be an elastomeric material. The elastomeric material may be a material selected from one or more of synthetic rubbers, thermoplastic elastomer (TPE), styrenics, thermoplastic polyolefin (TPO), LDPE, HDPE, LLDPE, and ULDPE.

The air outlet channel may comprise a venturi conduit. The venturi conduit may comprise an intermediate section of the air outlet channel. The intermediate section may have a reduced cross-sectional area compared to sections of the air outlet channel upstream and downstream of the intermediate section. The venturi circuit may improve aerosol formation.

The main cavity inlet may comprise a distribution chamber. The distribution chamber may comprise an enlarging cross-sectional area of the main inlet channel in a direction towards the main cavity. The distribution chamber may advantageously promote a homogeneous airflow through the cavity.

The aerosol-generating device may comprise an ancillary cavity for receiving an ancillary article. The ancillary article may comprise an ancillary aerosol-forming substrate. The ancillary cavity may be arranged upstream of the main cavity. The ancillary cavity may comprise an ancillary cavity opening for insertion of the ancillary article.

The aerosol-generating device may comprise an ancillary airflow channel extending from an ancillary air inlet to the main cavity via the ancillary cavity. The ancillary airflow channel may comprise an ancillary inlet channel extending from the ancillary air inlet to an ancillary cavity inlet. The ancillary airflow channel may comprise a supply channel extending from an ancillary cavity outlet to a supply inlet. The supply inlet may be configured as a supply inlet into the main inlet channel, or as a supply inlet into the main cavity.

The main cavity inlet valve assembly may comprise an additional valve part. The additional valve part of the main cavity inlet valve assembly may be movable between a closed position and an open position, wherein, in the closed position, the additional valve part is closing the supply inlet, and wherein, in the open position, the main cavity is fluidly connected to the supply channel. The additional valve part may be configured for being pushed by the main article from the closed position into the open position upon insertion of the main article into the main cavity.

The gate valve of the main cavity inlet valve assembly may be coupled to the additional valve part. The gate valve and the additional valve part may be formed as one piece, preferably one monolithic piece. The gate valve and the additional valve part may be configured for being pushed together from the closed position into the open position upon insertion of the main article into the main cavity. The compressible element may be connected to the gate valve of the main cavity inlet valve assembly via the additional valve part.

The gate valve of the main cavity inlet valve assembly and the additional valve part of the main cavity inlet valve assembly and the gate valve of the main cavity outlet valve assembly may be configured such that all three gate valves are pushed by the main article from the closed position into the open position upon insertion of the main article into the main cavity. The gate valve of the main cavity inlet valve assembly and the additional valve part of the main cavity inlet valve assembly and the gate valve of the main cavity outlet valve assembly may be configured such that all three gate valves are pushed simultaneously by the main article from the closed position into the open position upon insertion of the main

The aerosol-generating device may comprise an ancillary cavity outlet valve assembly comprising a gate valve. The gate valve of the ancillary cavity outlet valve assembly may be movable between a closed position and an open position. In the closed position of the gate valve of the ancillary cavity outlet valve assembly, the gate valve may be closing the ancillary cavity outlet. In the open position of the gate valve of the ancillary cavity outlet valve assembly, the ancillary cavity may be fluidly connected to the supply channel. The gate valve of the ancillary cavity outlet valve assembly may hermetically seal the ancillary cavity outlet in the closed position.

The gate valve of the ancillary cavity outlet valve assembly may be arranged in the ancillary cavity. The gate valve of the ancillary cavity outlet valve assembly may be configured for being pushed by the ancillary article from the closed position into the open position upon insertion of the ancillary article into the ancillary cavity.

The ancillary cavity outlet valve assembly may comprise a compressible element connected to the gate valve, preferably wherein the ancillary cavity outlet valve assembly is configured such that the compressible element is in a relaxed configuration when the gate valve is in the closed position.

The aerosol-generating device may comprise an ancillary cavity inlet valve assembly comprising a gate valve. The gate valve of the ancillary cavity inlet valve assembly may be movable between a closed position and an open position. In the closed position of the gate valve of the ancillary cavity inlet valve assembly, the gate valve may be sealing the ancillary cavity inlet. In the open position of the gate valve of the ancillary cavity inlet valve assembly, the ancillary cavity may be fluidly connected to the ancillary air inlet. The gate valve of the ancillary cavity inlet valve assembly may hermetically seal the ancillary cavity inlet in the closed position.

The gate valve of the ancillary cavity inlet valve assembly may be arranged in the ancillary cavity. The gate valve of the ancillary cavity inlet valve assembly may be configured for being pushed by the ancillary article from the blocking position into the open position upon insertion of the ancillary article into the ancillary cavity.

The ancillary cavity inlet valve assembly may comprise a compressible element connected to the gate valve. The ancillary cavity inlet valve assembly may be configured such that the compressible element is in a relaxed configuration when the gate valve is in the blocking position.

The aerosol-generating device may comprise an ancillary heating element configured for heating the ancillary article received in the ancillary cavity. The ancillary heating element may be any kind of heating element known to those skilled in the art. The ancillary heating element may be any kind of heating element as described herein. The aerosol-generating device may comprise a heater assembly, the heater assembly comprising both the main heating element and the ancillary heating element.

The ancillary heating element may be an inductive heating element. The ancillary heating element may comprise at least one inductor coil. The at least one inductor coil may be planar. The ancillary heating element may comprise at least one planar inductor coil and at least one planar susceptor element. The susceptor element may be part of the aerosol-generating device. The susceptor element may be part of the ancillary article.

The aerosol-generating device may be configured such that the main heating element and the ancillary heating element are independently controllable.

The main cavity and the ancillary cavity may be differently shaped or dimensioned for avoiding insertion of a wrong article following the key-lock principle.

The aerosol-generating device comprises a main axis extending between a proximal end and a distal end of the device. The ancillary cavity opening may be arranged in a lateral sidewall of the device such that the ancillary article may be inserted into the ancillary cavity via the ancillary cavity opening along an insertion direction, the insertion direction being substantially perpendicular to the main axis. The proximal end may comprise a mouthpiece.

The aerosol-generating device may comprise a sealing element arranged in proximity to the ancillary cavity opening. The sealing element may assist in establishing an air-tight connection between the ancillary article and the ancillary cavity opening when the ancillary article is inserted into the ancillary cavity.

The sealing element may be arranged on an outer sidewall of the aerosol-generating device. The sealing element may be arranged to surround the ancillary cavity opening.

The ancillary cavity inlet may comprise a distribution chamber. The distribution chamber may comprise an enlarging cross-sectional area of the ancillary inlet channel in a direction towards the ancillary cavity.

The main cavity may comprise first and second major boundary surfaces. The first and second major boundary surfaces of the main cavity may extend in facing parallel relations and defining a principal flow axis for fluid flowing through the main cavity. The device may be configured such that fluid flow, in use, from the main cavity inlet to the main cavity outlet is in a direction substantially parallel to the principal flow axis. The principal flow axis may be substantially parallel to the main axis of the aerosol-generating device.

An inner volume of the main cavity may be generally cuboid-shaped. A diameter of the first and second major boundary surfaces of the main cavity may be four times or more the length of a distance between the first and second major boundary surfaces of the main cavity.

The first and second major boundary surfaces of the main cavity may be spaced from one another by a distance of less than 10 millimeters, less than 9 millimeters, less than 8 millimeters, less than 7 millimeters, less than 6 millimeters, less than 5.5 millimeters, less than 5 millimeters, less than 4.5 millimeters, less than 4 millimeters, less than 3.5 millimeters, less than 3 millimeters, less than 2.5 millimeters.

The ancillary cavity may comprise first and second major boundary surfaces. The first and second major boundary surfaces of the ancillary cavity may extend in facing parallel relations and defining a principal flow axis for fluid flowing through the ancillary cavity. The device may be configured such that fluid flow, in use, from the ancillary cavity inlet to the ancillary cavity outlet is in a direction substantially parallel to the principal flow axis. The principal flow axis may be substantially parallel to the main axis of the aerosol-generating device.

An inner volume of the ancillary cavity may be generally cuboid-shaped. A diameter of the first and second major boundary surfaces of the ancillary cavity may be four times or more the length of a distance between the first and second major boundary surfaces of the ancillary cavity.

The first and second major boundary surfaces of the ancillary cavity may be spaced from one another by a distance of less than 10 millimeters, less than 9 millimeters, less than 8 millimeters, less than 7 millimeters, less than 6 millimeters, less than 5.5 millimeters, less than 5 millimeters, less than 4.5 millimeters, less than 4 millimeters, less than 3.5 millimeters, less than 3 millimeters, less than 2.5 millimeters.

One or both of the main cavity and the ancillary cavity may have a flat or planar shape. For example, at least one of the main cavity and the ancillary cavity may have a slot-like shape for insertion of a card-like shaped article, similar to a shape of a SIM card slot or an SD card slot, or other type of electronic card slot. For insertion of the aerosol-forming-generating article, at least one of the main cavity opening and the ancillary cavity opening may have the shape of a slot in a side wall of the aerosol-generating device. For example, the main cavity opening and the ancillary cavity opening may be formed as two slots having a longitudinal axis of extension that coincides with each other. Both the main cavity opening and the ancillary cavity opening have the same size and shape and both the main cavity opening and the ancillary cavity opening have the same size and shape, such that a specific aerosol-generating article can be received in either one of the cavities.

The main cavity opening and the ancillary cavity opening may have one or both of a different size and a different shape. The main cavity and the ancillary cavity may have one or both of a different size and a different shape. Thereby, only a specific article may be inserted into the respective cavity.

One or both of the main article and the ancillary article may have a flat or planar shape. For example, at least one of the main article and the ancillary article may have a card-like shape, similar to a shape of a SIM card or an SD card, or other type of electronics card. Both the main article and the ancillary article may have the same size and shape, such that either one of the aerosol-generating articles can be received in a specific cavity. The main article and the ancillary article may have one or both of a different size and a different shape. Thereby, only a specific article may be inserted into the respective cavity.

Non-limiting examples of structures of flat articles may be those shown in PCT/EP2022/084128 and WO2016/005531, these patent publications herewith incorporated by reference in their entirety.

One or both of the main article and the ancillary may be shaped to be non-stick or rod-like, for example as flat or planar articles. The article may therefore have a different look or feel from a conventional cigarette, when compared to the rod-like articles used for some conventional heat-not-burn devices. For example, a flat or planar article may be used that may be compact and easy to store. A flat or planar article may be stackable, thereby allowing the storage in a small volume. A flat or planar article may be made to be solid and rugged. A flat or planar article may be less likely to break, as it may not serve simultaneously as a mouth piece that resembles a mouthpiece of a conventional cigarette, but may be fully or at least partially incorporated into a body of the aerosol-generating device upon use for inhalation, and providing for a separate mouthpiece for the inhalation. A flat or planar article may be designed to be thinner in thickness as compared to a diameter of a stick-like or rod-like aerosol generating article, thereby allowing to further reduce a volume that needs to be heated, allowing to further increase the heater efficiency.

A tab-like or bar-like aerosol-generating device may be used in conjunction with flat or planar articles. A tab-like or bar-like aerosol-generating device may provide for a device that resembles commonly known e-Vapor devices, but still providing heat-not-burn technology. The tab-like or bar-like aerosol-generating device may conveniently be held and concealed in a hand of a user for discretion and inhalation purposes.

The aerosol-generating device may be configured as a “side loader” device. One or both of the main cavity opening and the ancillary cavity opening may be provided in a lateral side wall of the aerosol-generating device. The housing of the aerosol-generating device may comprise two large opposing major surfaces and two smaller opposing minor surfaces. One or both of the main cavity opening and the ancillary cavity opening may be arranged in one of the minor surfaces. One or both of the main cavity opening and the ancillary cavity opening may be arranged in one of the minor surfaces. The main cavity opening and the ancillary cavity opening may be arranged in opposing minor surfaces. Preferably, both of the main cavity opening and the ancillary cavity opening are arranged in the same minor surface. The main cavity opening and the ancillary cavity opening may be arranged at different longitudinal positions of the aerosol-generating device with respect to a longitudinal axis of the device, the longitudinal axis of the device extending between the proximal end of the device and the distal end of the device opposing the proximal end, preferably wherein the proximal end comprises a mouthpiece. The main cavity opening and the ancillary cavity opening may be arranged along a common longitudinal axis of the cavity openings. The common longitudinal axis of the cavity openings may be arranged substantially collinear with the longitudinal axis of the device. For example, the cutting angle between the common longitudinal axis of the cavity openings and the longitudinal axis of the device may be less than 10 degrees, preferably less than 5 degrees.

A “side loader” configuration as described above may advantageously improve handiness of the aerosol-generating device. Convenience for a user using the device may be improved. A side loader configuration may advantageously be combined with the airflow configuration comprising one or more valve assemblies as disclosed herein.

One or both of the main cavity and the ancillary cavity may comprise an insertion mechanism for inserting the respective main article or the ancillary article into the respective main cavity or ancillary cavity. One or both of the main cavity and the ancillary cavity may comprise an ejection mechanism for ejecting the respective main article or the ancillary article from the respective main cavity or ancillary cavity. One or both of the main cavity and the ancillary cavity may comprise an injection and ejection mechanism for inserting the respective main article or the ancillary article into the respective main cavity or ancillary cavity and for ejecting the respective main article or the ancillary article from the respective main cavity or ancillary cavity.

The insertion and ejection mechanism may comprise one or more of a tray mechanism, a push-pull mechanism, and a push-push mechanism, or a tray mechanism using either push-pull or a push-push mechanism. The main cavity and the ancillary cavity may have the same insertion and ejection mechanism. The main cavity and the ancillary cavity may have different insertion and ejection mechanisms.

An insertion mechanism or an ejection mechanism, preferably an insertion and ejection mechanism, may advantageously improve handiness of the aerosol-generating device. Convenience for a user using the device may be improved by the mechanism. The mechanism may advantageously be combined with the airflow configuration comprising one or more valve assemblies as disclosed herein.

The mechanism may comprise a security lock for inhibiting accidental ejection of the respective article.

The insertion mechanism, or the ejection mechanism, or the insertion and ejection mechanism may be arranged not to negatively interfere with any of the valve assemblies as described herein. A movable gate valve of a valve assembly as described herein may, however, be configured to form part of an ejection mechanism. For example, a gate valve may help ejecting of an article when moving from the open position into the closed position.

One or both of the main cavity and the ancillary cavity may comprise a tray mechanism for insertion and ejection of the respective main article or ancillary article. For example, the tray mechanism may comprise an insertable tray for receiving the respective article. The insertable tray may be configured for being insertable into the respective cavity and being removable from the respective cavity. The insertable tray may form part of the aerosol-generating device or may form part of the respective main article or ancillary article. The tray mechanism may comprise a slidable tray for receiving the respective article. The slidable tray may be configured to be slidable into and out of the respective cavity. The slidable tray may be permanently connected to the aerosol-generating device. The slidable tray mechanism may be similar to a slidable tray mechanism known for CD players or card holders. Preferably, the slidable tray mechanism does not comprise a motor.

One or both of the main cavity and the ancillary cavity may comprise a push-pull insertion and ejection mechanism for insertion and ejection of the respective article.

One or both of the main cavity and the ancillary cavity may comprise a push-push insertion and ejection mechanism for insertion and ejection of the respective article. The push-push insertion and ejection mechanism may be similar to those mechanisms known for SD cards or SIM cards, for example, the Molex push-push ejection system for SD/SIM (push-to-insert, push-to-eject). The respective cavity may comprise a socket for removably holding a card-like main article or ancillary article, respectively.

Insertion and injection mechanisms may comprise those described in U.S. Pat. Nos. 6,394,827 and 6,478,591, these references herewith incorporated by reference in their entirety.

One or both of the main cavity and the ancillary cavity may comprise a door mechanism for opening and closing the respective cavity opening. The door mechanism may comprise a spring-biased door. The door mechanism may comprise a tilting door. The tilting door may be forced open by insertion of the respective main article or ancillary article.

The aerosol-generating device may comprise one or more additional cavities arranged upstream of the ancillary cavity and the main cavity. Each of the one or more additional cavities may comprise a respective cavity opening for insertion of a respective article comprising an aerosol-forming substrate. Each of the one or more additional cavities may comprise an additional airflow channel similar to the ancillary airflow channel. Each of the one or more additional cavities may comprise one or more additional valve assemblies similar to the valve assemblies of the ancillary cavity. Each of the one or more additional cavities may be a duplicate of the ancillary cavity.

The aerosol-generating device may comprise a controller. The controller may be configured to individually control operation of the main heating element and the ancillary heating element.

The aerosol-generating device may comprise a main sensor for detecting whether a main article is inserted into the main cavity. The controller may be adapted to control the main heating element in dependence of a signal received from the main sensor. The aerosol-generating device may comprise an ancillary sensor for detecting whether an ancillary article is inserted into the ancillary cavity. The controller may be adapted to control the ancillary heating element in dependence of a signal received from the ancillary sensor. The controller may be adapted to control one or both of the main heating element and the ancillary heating element in dependence of one or both of a signal received from the main sensor and a signal received from the ancillary sensor.

The aerosol-generating device may comprise a power source. The power source may be configured to supply power to one or both of the main heating element and the ancillary heating element.

According to an embodiment of the invention there is provided an aerosol-generating system comprising the aerosol-generating device as described herein and a main article comprising a main aerosol-forming substrate. The main article may be shaped to closely conform to the shape of the main cavity. The system may comprise a main article and an ancillary article. The ancillary article may be shaped to closely conform to the shape of the ancillary cavity.

The main article may comprise a cap element configured to be grasped by a hand of a user. The cap element may comprise a sealing element configured to seal an opening of the main cavity when the main article is inserted into the main cavity.

The main article may have any kind of geometrical shape. For example, the main article may have a round shape, for example a generally spherical shape. For example, the main article may have a cuboid shape, for example a planar or flat type shape, for example a generally SD or SIM card-like shape. The main cavity may have any kind of geometrical shape. For example, the main cavity may have a round shape, for example a generally spherical shape. For example, the main cavity may have a cuboid shape, for example a generally SD or SIM card slot-like shape. The main article and the main cavity may have corresponding shapes.

As used herein, the term “main article” refers to an aerosol-generating article configured for being inserted into the main cavity of the aerosol-generating device. The main article may comprise a main aerosol-forming substrate. The main aerosol-forming substrate may be any type of aerosol-forming substrate as described herein.

The main article may be a dummy article not comprising an aerosol-forming substrate. The purpose of the dummy article may be to close the main cavity opening. The purpose of the dummy article may be to open the gate valves of the main cavity.

The ancillary article may comprise a cap element configured to be grasped by a hand of a user. The cap element may comprise a sealing element configured to seal an opening of the ancillary cavity when the ancillary article is inserted into the ancillary cavity.

The ancillary article may have any kind of geometrical shape. For example, the ancillary article may have a round shape, for example a generally spherical shape. For example, the ancillary article may have a cuboid shape, for example a generally SD or SIM card-like shape. The ancillary cavity may have any kind of geometrical shape. For example, the ancillary cavity may have a round shape, for example a generally spherical shape. For example, the ancillary cavity may have a cuboid shape, for example a generally SD or SIM card slot-like shape. The ancillary article and the ancillary cavity may have corresponding shapes.

As used herein, the term “ancillary article” refers to an aerosol-generating article configured for being inserted into the ancillary cavity of the aerosol-generating device. The ancillary article may comprise an ancillary aerosol-forming substrate. The ancillary aerosol-forming substrate may be any type of aerosol-forming substrate as described herein.

The ancillary article may be a dummy article not comprising an aerosol-forming substrate.

The main article and the ancillary article may be identical articles. The main article and the ancillary article may be different tapes of articles. For example, the main article and the ancillary article may have different shapes. For example, the main article and the ancillary article may comprise one or both of different types and different amounts of aerosol-forming substrates. The main aerosol-forming substrate and the ancillary aerosol-forming substrate may have identical compositions.

The main aerosol-forming substrate and the ancillary aerosol-forming substrate may have different compositions. A user may individualize a user experience by combining different main articles and ancillary articles with different compositions and flavors as she or he wishes.

The main heating element may be any kind of heating element as described herein. The ancillary heating element may be any kind of heating element as described herein.

The heating element may be a dielectric or capacitive-type heating element. For example, dielectric or capacitive-type heating element can be used having two or more flat or planar electrodes arranged to removably receive an exemplary flat or planar aerosol-generating article therebetween, interconnected via an impedance matching circuit to an AC source, for generating microwaves between the electrodes for capacitive/dielectric heating.

The heating element may be a resistive or Joule-type heating element, for example being part of the aerosol-forming device, the exemplary flat or planar aerosol-forming article, or both. The resistive heating element may take any suitable form. For example, the resistive heating element may take the form of one or more flexible heating foils on a dielectric substrate, such as polyimide. The flexible heating foils can be shaped to conform to the perimeter of the respective cavity. Alternatively, a resistive heating element may take the form of a metallic grid or grids, a flexible printed circuit board, a molded interconnect device (MID), ceramic heater, flexible carbon fibre heater or may be formed using a coating technique, such as plasma vapour deposition, on a suitable shaped substrate. A resistive heating element may also be formed using a metal having a defined relationship between temperature and resistivity. In such an exemplary device, the metal may be formed as a track between two layers of suitable insulating materials. A resistive heating element formed in this manner may be used to both heat and monitor the temperature of the resistive heating element during operation. It is also possible that the resistive heating elements are part of the aerosol-forming article, for example a flat or planar aerosol-forming article, for example but not limited to a plate-like shape or having electrically resistive tracks arranged on a flat heater substrate, for example as described in WO2016/005530 and WO2016/005533, showing a cartridge with integrated heating elements, these references herewith incorporated by reference in their entirety.

The heating element may be a radiation-based heating element, for example but not limited to a semiconductor based heating element, having an array of individual radiation-based heating elements, for example as shown in WO2017/182249, this reference incorporated by reference in its entirety.

The radiation-based heating element may a non-contact heater, for example as shown in WO2022/207447, this reference incorporated by reference in its entirety.

The radiation-based heating element may comprise a radiation source that can radiate onto a surface or layer of a flat aerosol-forming article to cause aerosolization or vaporization. The radiation source may be configured to emit electromagnetic radiation. The electromagnetic radiation may be microwaves, far infrared, infrared, near infrared, or visible light.

The radiation source may be a photonic device or laser irradiation device. The photonic device may be a light-emitting diode (LED). The radiation source may be a perovskite LED.

The photonic device may be a thin film that can irradiate electromagnetic radiation, preferably infrared radiation.

The radiation source may comprise an infrared radiating coating, for example an NiCr₂O₄ powder coating or other high-emissivity ceramic coating that can emit infrared light.

The heating element may be an induction heating element. The induction heating element may comprise one or more induction coils which each may surround the main cavity or the ancillary cavity. For example, a helical induction coil may extend around the first and second major boundary surfaces of a cavity. The longitudinal axis of the or each induction coil may be substantially parallel to the principal flow axis. For example, the heating element can be configured to have planar coils configured for inductively heating a flat susceptor inside, outside, or in contact with the aerosol-forming substrate of the flat or planar aerosol-forming article, for example as described in WO2015/177043 or WO2015/177044, these references herewith incorporate by reference in their entirety.

As used herein, the term “longitudinal axis” in respect of an induction coil refers to an axis extending through the centre of the coil in a direction generally perpendicular to the turns of the coil.

The induction heating element may be arranged to inductively heat a susceptor. The induction heating element may comprise one or more induction coils located adjacent the first and/or second major boundary surface of a respective main cavity or ancillary cavity. The longitudinal axis of the or each induction coil may be substantially perpendicular to the principal flow axis, for example and to a plane defined by the first major boundary surface.

The one or more induction coils may be planar. For example, a planar induction coil may be located adjacent and in parallel to one of the first and second major boundary surfaces of a respective cavity. For example, a first planar induction coil may be located adjacent and in parallel to the first major boundary surface and a second planar induction coil may be located adjacent and in parallel to the second major boundary surface.

The susceptor may be part of an aerosol-generating article within the main cavity or the ancillary cavity. The susceptor may be part of the aerosol-generating device. For example, the susceptor may be arranged on an inner side of the cavity. For example, one or both of the first and second major boundary surfaces of a respective cavity may comprise a susceptor material.

In use, a susceptor may be inductively heated by the or each induction coil. The susceptor then, in turn, conductively, convectively and/or radiatively heats the aerosol-forming substrate located in proximity to the susceptor.

A ‘susceptor’ refers to an element that heats up when subjected to a varying or alternating magnetic field. Usually, a susceptor is conductive, and heating of the susceptor is the result of eddy currents being induced in the susceptor or hysteresis losses. Both hysteresis losses and eddy currents can occur in a susceptor. A susceptor may include graphite, molybdenum, silicon carbide, stainless steels, niobium, aluminium and any other conductive elements. Preferably, the susceptor element is a ferrite element. The material and the geometry for the susceptor may be chosen to provide a desired electrical resistance and heat generation.

In the operation of an induction heater, a high frequency alternating current is passed through one or more induction coils to generate one or more corresponding alternating magnetic fields that induce a voltage in a susceptor of an article. The induced voltage causes a current to flow in the susceptor and this current causes Joule heating of the susceptor that in turn heats the aerosol-forming substrate. If the susceptor is ferromagnetic, hysteresis losses in the susceptor may also generate heat.

The term ‘high frequency’ denotes a frequency ranging from about 500 Kilohertz (KHz) to about 30 Megahertz (MHz) (including the range of 500 KHz to 30 MHz), in particular from about 1 Megahertz (MHz) to about 10 MHz (including the range of 1 MHz to 10 MHz), and even more particularly from about 5 Megahertz (MHz) to about 7 Megahertz (MHz) (including the range of 5 MHz to 7 MHz).

Throughout the present disclosure, the term ‘magnetic field’ may refer to a varying or alternating magnetic field.

Throughout the present disclosure, the term ‘current’ may refer to an alternating current.

The heating element may be configured or configurable to heat an article received in the cavity to a temperature less than 400 degrees centigrade, for example less than 300 degrees centigrade, say less than 270 degrees centigrade. In some embodiments, the heater may be configured or configurable to heat an article for forming an aerosol received in the heating chamber to a temperature less than 250, 225, 200, 175 or 150 degrees centigrade, for example less than 140, 130, 120, 110, 100 or 90 degrees centigrade.

The aerosol-generating device may comprise a power source or power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

As used herein, the term “aerosol-forming substrate” refers to a substrate capable of releasing volatile compounds that can form an aerosol. Such volatile compounds may be released by heating the aerosol-forming substrate. The aerosol-forming substrate may be in solid form or may be in liquid form. The aerosol-forming substrate may be solid or liquid or may comprise both solid and liquid components. An aerosol-forming substrate may be part of an aerosol-generating article. The terms ‘aerosol’ and ‘vapor’ are used synonymously.

The aerosol-forming substrate may comprise a pharmaceutically active compound. The aerosol-forming substrate may comprise one or more of: tobacco, nicotine, a gel composition and a flavour agent. The aerosol-forming substrate may comprise nicotine.

The aerosol-forming substrate may comprise one or more of botanicals, botanical drugs, and pharmaceutical ingredients. The one or more of botanicals, botanical drugs, and pharmaceutical ingredients may be part of an aerosol-forming substrate that can be at least partially aerosolized with an aerosol former for inhalation. The aerosol-forming substrate may comprise one or more of botanicals, botanical drugs, and pharmaceutical ingredients, wherein the substrate has an aerosol former content of between 5% and 30% by weight on a dry weight basis.

Preferably, the aerosol-forming substrate comprises plant material and an aerosol former. Preferably, the plant material is a plant material comprising an alkaloid, more preferably a plant material comprising nicotine, and more preferably a tobacco-containing material.

Preferably, the aerosol-forming substrate comprises at least 70 percent of plant material, more preferably at least 90 percent of plant material by weight on a dry weight basis. Preferably, the aerosol-forming substrate comprises less than 95 percent of plant material by weight on a dry weight basis, such as from 90 to 95 percent of plant material by weight on a dry weight basis.

Preferably, the aerosol-forming substrate comprises at least 5 percent of aerosol former, more preferably at least 10 percent of aerosol former by weight on a dry weight basis. Preferably, the aerosol-forming substrate comprises less than 30 percent of aerosol former by weight on a dry weight basis, such as from 5 to 30 percent of aerosol former by weight on a dry weight basis.

In some particularly preferred embodiments, the aerosol-forming substrate comprises plant material and an aerosol former, wherein the substrate has an aerosol former content of between 5% and 30% by weight on a dry weight basis. The plant material is preferably a plant material comprising an alkaloid, more preferably a plant material comprising nicotine, and more preferably a tobacco-containing material. Alkaloids are a class of naturally occurring nitrogen-containing organic compounds. Alkaloids are found mostly in plants, but are also found in bacteria, fungi and animals. Examples of alkaloids include, but are not limited to, caffeine, nicotine, theobromine, atropine and tubocurarine. A preferred alkaloid is nicotine, which may be found in tobacco.

An aerosol-forming substrate may comprise nicotine. An aerosol-forming substrate may comprise tobacco, for example may comprise a tobacco-containing material containing volatile tobacco flavour compounds, which are released from the aerosol-forming substrate upon heating. In preferred embodiments an aerosol-forming substrate may comprise homogenised tobacco material, for example cast leaf tobacco. The aerosol-forming substrate may comprise both solid and liquid components. The aerosol-forming substrate may comprise a tobacco-containing material containing volatile tobacco flavour compounds, which are released from the substrate upon heating. The aerosol-forming substrate may comprise a non-tobacco material. The aerosol-forming substrate may further comprise an aerosol former. Examples of suitable aerosol formers are glycerine and propylene glycol.

As used herein, the term “tobacco material” is used to describe any material comprising tobacco, including, but not limited to, tobacco leaf, tobacco rib, tobacco stem, tobacco stalk, tobacco dust, expanded tobacco, reconstituted tobacco material and homogenised tobacco material.

As used herein, the term “homogenised tobacco” denotes a material formed by agglomerating particulate tobacco. Homogenized tobacco may include reconstituted tobacco or cast leaf tobacco, or a mixture of both. The term “reconstituted tobacco” refers to paper-like material that can be made from tobacco by-products, such as tobacco fines, tobacco dusts, tobacco stems, or a mixture of the foregoing. Reconstituted tobacco can be made by extracting the soluble chemicals in the tobacco by-products, processing the leftover tobacco fibers into a sheet, and then reapplying the extracted materials in concentrated form onto the sheet.

The term “cast leaf” is used herein to refer to a sheet product made by a casting process that is based on casting a slurry comprising plant particles (for example, clove particles, or tobacco particles and clove particles in a mixture) and a binder (for example, guar gum) onto a supportive surface, such as a belt conveyor, drying the slurry and removing the dried sheet from the supportive surface. An example of the casting or cast leaf process is described in, for example, U.S. Pat. No. 5,724,998 for making cast leaf tobacco. In a cast leaf process, particulate plant materials are mixed with a liquid component, typically water, to form a slurry. Other added components in the slurry may include fibres, a binder and an aerosol former. The particulate plant materials may be agglomerated in the presence of the binder. The slurry is cast onto a supportive surface and dried to form a sheet of homogenised plant material.

The aerosol-forming substrate may comprise one or more flavourants. As used herein, the term “flavourant” refers to a composition having organoleptic properties, which provide a sensory experience to the user, for example to enhance the flavour of aerosol. A flavourant can be used to deliver a gustatory sensation (taste), an olfactory sensation (smell), or both a gustatory and an olfactory sensation to the user, for example when inhaling the aerosol.

As used herein, the term “aerosol-generating article” refers to an article comprising an aerosol-forming substrate that is capable of releasing volatile compounds that can form an aerosol. An aerosol-generating article may be disposable. An aerosol-generating article comprising an aerosol-forming substrate comprising tobacco may be referred to herein as a tobacco stick.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

As used herein, the terms ‘proximal’, ‘distal’, ‘downstream’ and ‘upstream’ are used to describe the relative positions of components, or portions of components, of the aerosol-generating device and the aerosol-generating article in relation to the direction in which a user draws on the aerosol-generating device or aerosol-generating article during use thereof.

The aerosol-generating device may comprise a mouth end through which in use an aerosol exits the aerosol-generating device and is delivered to a user. In use, a user draws on the proximal or mouth end of the aerosol-generating device in order to inhale an aerosol generated by the aerosol-generating device. The aerosol-generating device comprises a distal end opposed to the proximal or mouth end. The proximal or mouth end of the aerosol-generating device may also be referred to as the downstream end and the distal end of the aerosol-generating device may also be referred to as the upstream end. Components, or portions of components, of the aerosol-generating device may be described as being upstream or downstream of one another based on their relative positions between the proximal, downstream or mouth end and the distal or upstream end of the aerosol-generating device.

Below, there is provided a non-exhaustive list of non-limiting examples. Any one or more of the features of these examples may be combined with any one or more features of another example, embodiment, or aspect described herein.

### EXAMPLE E1

An aerosol-generating device comprising
a main cavity arranged for receiving a main article having a main aerosol-forming substrate;
a main airflow channel extending from a main air inlet to an air outlet via the main cavity, the main airflow channel comprising a main inlet channel extending from the main air inlet to a main cavity inlet, and an air outlet channel extending from a main cavity outlet to the air outlet; and
a main cavity outlet valve assembly comprising a gate valve, the gate valve being movable between a closed position and an open position, wherein, in the closed position, the gate valve is closing the main cavity outlet, and wherein, in the open position, the main cavity is fluidly connected to the air outlet.

### EXAMPLE E2

The aerosol-generating device according to Example E1, wherein the gate valve of the main cavity outlet valve assembly is arranged in the main cavity.

### EXAMPLE E3

The aerosol-generating device according to Example E1 or Example E2, wherein the gate valve of the main cavity outlet valve assembly is configured for being pushed by the main article from the closed position into the open position upon insertion of the main article into the main cavity.

### EXAMPLE E4

The aerosol-generating device according to Example E3, wherein the main cavity outlet valve assembly comprises a compressible element connected to the gate valve, preferably wherein the main cavity outlet valve assembly is configured such that the compressible element is in a relaxed configuration when the gate valve is in the closed position.

### EXAMPLE E5

The aerosol-generating device according to any of the preceding examples, comprising a main cavity inlet valve assembly comprising a gate valve, the gate valve being movable between a closed position and an open position, wherein, in the closed position, the gate valve is closing the main cavity inlet, and wherein, in the open position, the main cavity is fluidly connected to the main air inlet.

### EXAMPLE E6

The aerosol-generating device according to Example E5, wherein the gate valve of the main cavity inlet valve assembly is arranged in the main cavity.

### EXAMPLE E7

The aerosol-generating device according to Example E5 or Example E6, wherein the gate valve of the main cavity inlet valve assembly is configured for being pushed by the main article from the closed position into the open position upon insertion of the main article into the main cavity, such that the gate valve of the main cavity inlet valve assembly and the gate valve of the main cavity outlet valve assembly can both be pushed by the main article.

### EXAMPLE E8

The aerosol-generating device according to Example E7, wherein the main cavity inlet valve assembly comprises a compressible element connected to the gate valve, preferably wherein the main cavity inlet valve assembly is configured such that the compressible element is in a relaxed configuration when the gate valve is in the closed position.

### EXAMPLE E9

The aerosol-generating device according to any of the preceding examples, comprising a main heating element configured for heating the main article received in the main cavity, preferably wherein the main heating element comprises at least one inductor coil, more preferably at least one planar inductor coil.

### EXAMPLE E10

The aerosol-generating device according to any of the preceding examples, wherein the main cavity comprises a main cavity opening for insertion of the main article.

### EXAMPLE E11

The aerosol-generating device according to Example E10,
wherein the aerosol-generating device comprises a main axis extending between a proximal end and a distal end of the device, and
wherein the main cavity opening is arranged in a lateral sidewall of the device such that the main article may be inserted into the main cavity via the main cavity opening along an insertion direction, the insertion direction being substantially perpendicular to the main axis,
preferably wherein the proximal end comprises a mouthpiece.

### EXAMPLE E12

The aerosol-generating device according to Example E11, comprising a sealing element arranged in proximity to the main cavity opening, preferably, wherein the sealing element comprises an elastic material, more preferably an elastomeric material, more preferably a material selected from one or more of: synthetic rubbers, thermoplastic elastomer (TPE), styrenics, thermoplastic polyolefin (TPO), LDPE, HDPE, LLDPE, and ULDPE.

### EXAMPLE E13

The aerosol-generating device according to any of the preceding examples, wherein the air outlet channel comprises a venturi conduit, and wherein the venturi conduit comprises an intermediate section of the air outlet channel, the intermediate section having a reduced cross-sectional area compared to sections of the air outlet channel upstream and downstream of the intermediate section.

### EXAMPLE E14

The aerosol-generating device according to any of the preceding examples, wherein the main cavity inlet comprises a distribution chamber, the distribution chamber comprising an enlarging cross-sectional area of the main inlet channel in a direction towards the main cavity.

### EXAMPLE E15

The aerosol-generating device according to any of the preceding examples, comprising
an ancillary cavity arranged upstream of the main cavity for receiving an ancillary article having an ancillary aerosol-forming substrate; and
an ancillary airflow channel extending from an ancillary air inlet to the main cavity via the ancillary cavity, the ancillary airflow channel comprising an ancillary inlet channel extending from the ancillary air inlet to an ancillary cavity inlet, and a supply channel extending from an ancillary cavity outlet to a supply inlet, wherein the supply inlet is configured as a supply inlet into the main inlet channel, or as a supply inlet into the main cavity.

### EXAMPLE E16

The aerosol-generating device according to Example E15, comprising an ancillary cavity outlet valve assembly comprising a gate valve, the gate valve being movable between a closed position and an open position, wherein, in the closed position, the gate valve is closing the ancillary cavity outlet, and wherein, in the open position, the ancillary cavity is fluidly connected to the supply channel.

### EXAMPLE E17

The aerosol-generating device according to Example E16, wherein the gate valve of the ancillary cavity outlet valve assembly is arranged in the ancillary cavity.

### EXAMPLE E18

The aerosol-generating device according to Example E16 or Example E17, wherein the gate valve of the ancillary cavity outlet valve assembly is configured for being pushed by the ancillary article from the closed position into the open position upon insertion of the ancillary article into the ancillary cavity.

### EXAMPLE E19

The aerosol-generating device according to Example E18, wherein the ancillary cavity outlet valve assembly comprises a compressible element connected to the gate valve, preferably wherein the ancillary cavity outlet valve assembly is configured such that the compressible element is in a relaxed configuration when the gate valve is in the closed position.

### EXAMPLE E20

The aerosol-generating device according to any of Examples E15 to E19, comprising an ancillary cavity inlet valve assembly comprising a gate valve, the gate valve being movable between a closed position and an open position, wherein, in the closed position, the gate valve is sealing the ancillary cavity inlet, and wherein, in the open position, the ancillary cavity is fluidly connected to the ancillary air inlet.

### EXAMPLE E21

The aerosol-generating device according to Example E20, wherein the gate valve of the ancillary cavity inlet valve assembly is arranged in the ancillary cavity.

### EXAMPLE E22

The aerosol-generating device according to Example E20 or Example E21, wherein the gate valve of the ancillary cavity inlet valve assembly is configured for being pushed by the ancillary article from the blocking position into the open position upon insertion of the ancillary article into the ancillary cavity.

### EXAMPLE E23

The aerosol-generating device according to Example E22, wherein the ancillary cavity inlet valve assembly comprises a compressible element connected to the gate valve, preferably wherein the ancillary cavity inlet valve assembly is configured such that the compressible element is in a relaxed configuration when the gate valve is in the blocking position.

### EXAMPLE E24

The aerosol-generating device according to any of Examples E15 to E23, comprising an ancillary heating element configured for heating the ancillary article received in the ancillary cavity, preferably wherein the ancillary heating element comprises at least one inductor coil, preferably at least one planar inductor coil.

### EXAMPLE E25

The aerosol-generating device according to a combination of Examples E9 and E24, wherein the device is configured such that the main heating element and the ancillary heating element are independently controllable.

### EXAMPLE E26

The aerosol-generating device according to any of Examples E15 to E25, wherein the main cavity and the ancillary cavity are differently shaped for avoiding insertion of a wrong article following the key-lock principle.

### EXAMPLE E27

The aerosol-generating device according to any of Examples E15 to E26, wherein the ancillary cavity comprises an ancillary cavity opening for insertion of the ancillary article.

### EXAMPLE E28

The aerosol-generating device according to Example E27,
wherein the aerosol-generating device comprises a main axis extending between a proximal end and a distal end of the device, and
wherein the ancillary cavity opening is arranged in a lateral sidewall of the device such that the ancillary article may be inserted into the ancillary cavity via the ancillary cavity opening along an insertion direction, the insertion direction being substantially perpendicular to the main axis,
preferably wherein the proximal end comprises a mouthpiece.

### EXAMPLE E29

The aerosol-generating device according to Example E28, comprising a sealing element arranged in proximity to the ancillary cavity opening, preferably, wherein the sealing element comprises an elastic material, more preferably an elastomeric material, more preferably a material selected from one or more of: synthetic rubbers, thermoplastic elastomer (TPE), styrenics, thermoplastic polyolefin (TPO), LDPE, HDPE, LLDPE, and ULDPE.

### EXAMPLE E30

The aerosol-generating device according to any of Examples E15 to E29, wherein the ancillary cavity inlet comprises a distribution chamber, the distribution chamber comprising an enlarging cross-sectional area of the ancillary inlet channel in a direction towards the ancillary cavity.

### EXAMPLE E31

The aerosol-generating device according any of Examples E15 to E30,
wherein the ancillary cavity comprises first and second major boundary surfaces, the first and second major boundary surfaces of the ancillary cavity extending in facing parallel relations and defining a principal flow axis for fluid flowing through the ancillary cavity, wherein the device is configured such that fluid flow, in use, from the ancillary cavity inlet to the ancillary cavity outlet is in a direction substantially parallel to the principal flow axis.

### EXAMPLE E32

The aerosol-generating device according to Example E31, wherein the inner volume of the ancillary cavity is generally cuboid-shaped, preferably wherein a diameter of the first and second major boundary surfaces of the ancillary cavity equals at least four times a distance between the first and second major boundary surfaces of the ancillary cavity.

### EXAMPLE E33

The aerosol-generating device according to Example E31 or Example E32, wherein the first and second major boundary surfaces of the ancillary cavity are spaced from one another by a distance of less than 5 millimeters.

### EXAMPLE E34

The aerosol-generating device according any of the preceding examples,
wherein the main cavity comprises first and second major boundary surfaces, the first and second major boundary surfaces of the main cavity extending in facing parallel relations and defining a principal flow axis for fluid flowing through the main cavity,
wherein the device is configured such that fluid flow, in use, from the main cavity inlet to the main cavity outlet is in a direction substantially parallel to the principal flow axis.

### EXAMPLE E35

The aerosol-generating device according to Example E34, wherein the inner volume of the main cavity is generally cuboid-shaped, preferably wherein a diameter of the first and second major boundary surfaces of the main cavity equals at least four times a distance between the first and second major boundary surfaces of the main cavity.

### EXAMPLE E36

The aerosol-generating device according to Example E34 or Example E35, wherein the first and second major boundary surfaces of the main cavity are spaced from one another by a distance of less than 5 millimeters.

### EXAMPLE E37

The aerosol-generating device according to any of the preceding examples, comprising one or both of a controller and a power source.

### EXAMPLE E38

An aerosol-generating system comprising the aerosol-generating device according to any of the preceding examples and a main article comprising a main aerosol-forming substrate, preferably wherein the main article is shaped to closely conform to the shape of the main cavity.

### EXAMPLE E39

The aerosol-generating system according to Example E38, wherein the main article comprises a cap element configured to be grasped by a hand of a user, preferably wherein the cap element comprises a sealing element configured to seal an opening of the main cavity when the main article is inserted into the main cavity.

### EXAMPLE E40

An aerosol-generating device comprising
a main cavity arranged for receiving a main article having a main aerosol-forming substrate; and
an ancillary cavity for receiving an ancillary article having an ancillary aerosol-forming substrate.

### EXAMPLE E41

The device according to Example E40 or according to any of Examples E1 to E37, wherein one or both of the main cavity and the ancillary cavity have a flat or planar shape, preferably
wherein at least one of the main cavity and the ancillary cavity have a slot-like shape for insertion of a card-like shaped article, for example a shape similar to a SIM card slot or an SD card slot.

### EXAMPLE E42

The device according to Example E41, wherein at least one of the main cavity opening and the ancillary cavity opening have the shape of a slot in a side wall of the aerosol-generating device.

### EXAMPLE E43

The device according to Example E42, wherein both of the main cavity opening and the ancillary cavity opening are formed as slots having longitudinal axes of extension that are parallel to each other, preferably wherein the longitudinal axes of extension are aligned to form a common longitudinal axis.

### EXAMPLE E44

The device according to Example E43, wherein the longitudinal axes of the slots are parallel to a longitudinal axis of the aerosol-generating device, the longitudinal axis of the aerosol-generating device extending between a proximal end and a distal end of the device.

### EXAMPLE E45

The aerosol-generating device according to any of Examples E40 to E44 or according to any of Examples E1 to E37, wherein both the main cavity opening and the ancillary cavity opening have the same size and shape.

### EXAMPLE E46

The aerosol-generating device according to any of Examples E40 to E45 or according to any of Examples E1 to E37, wherein the main cavity opening and the ancillary cavity opening have one or both of a different size and a different shape.

### EXAMPLE E47

The device according to any of Examples E40 to E46, wherein the ancillary cavity is arranged upstream of the main cavity.

### EXAMPLE E48

The device according to Example E47, comprising
a main airflow channel extending from a main air inlet to an air outlet via the main cavity, the main airflow channel comprising a main inlet channel extending from the main air inlet to a main cavity inlet, and an air outlet channel extending from a main cavity outlet to the air outlet; and
an ancillary airflow channel extending from an ancillary air inlet to the main cavity via the ancillary cavity, the ancillary airflow channel comprising an ancillary inlet channel extending from the ancillary air inlet to an ancillary cavity inlet, and a supply channel extending from an ancillary cavity outlet to a supply inlet, wherein the supply inlet is configured as a supply inlet into the main inlet channel, or as a supply inlet into the main cavity.

### EXAMPLE E49

The device according to Example E48, comprising a main cavity outlet valve assembly comprising a gate valve, the gate valve being movable between a closed position and an open position, wherein, in the closed position, the gate valve is closing the main cavity outlet, and wherein, in the open position, the main cavity is fluidly connected to the air outlet.

### EXAMPLE E50

The device according to any of Examples E40 to E49, further comprising the additional features according to any of Examples E1 to E37.

### EXAMPLE E51

The aerosol-generating device according to any of Examples E40 to E49 or according to any of Examples E1 to E37, wherein one or both of the main cavity and the ancillary cavity comprise a tray mechanism for insertion and ejection of the respective article.

### EXAMPLE E52

The aerosol-generating device according to any of Examples E40 to E49 or according to any of Examples E1 to E37, wherein one or both of the main cavity and the ancillary cavity comprise a push-push mechanism for insertion and ejection of the respective article.

### EXAMPLE E53

The aerosol-generating device according to any of Examples E40 to E49 or according to any of Examples E1 to E37, wherein one or both of the main cavity and the ancillary cavity comprise a push-pull mechanism for insertion and ejection of the respective article.

Features described in relation to one embodiment may equally be applied to other embodiments of the invention.

The invention will be further described, by way of example only, with reference to the accompanying drawings in which:

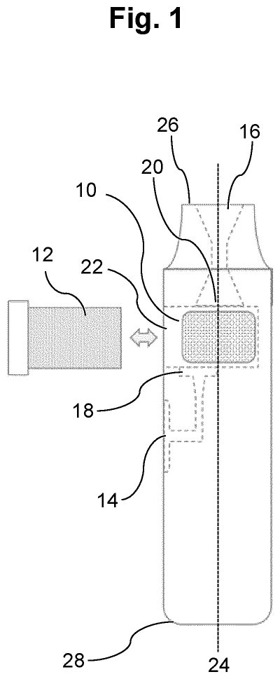

FIG. 1 shows an aerosol-generating system;

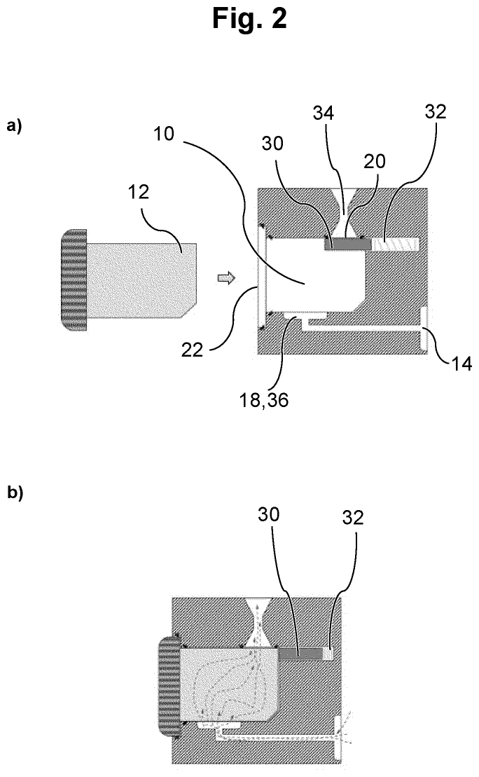

FIGS. 2a and 2b show part of an aerosol-generating system in accordance with FIG. 1;

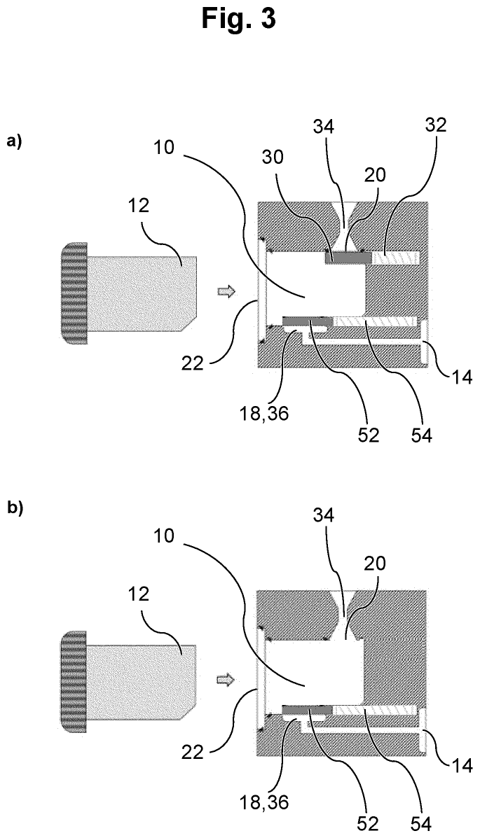

FIGS. 3a and 3b show parts of aerosol-generating systems in accordance with FIG. 1;

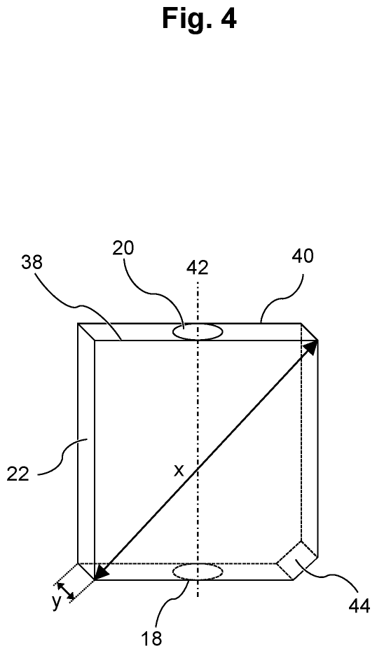

FIG. 4 shows a main cavity of an aerosol-generating device;

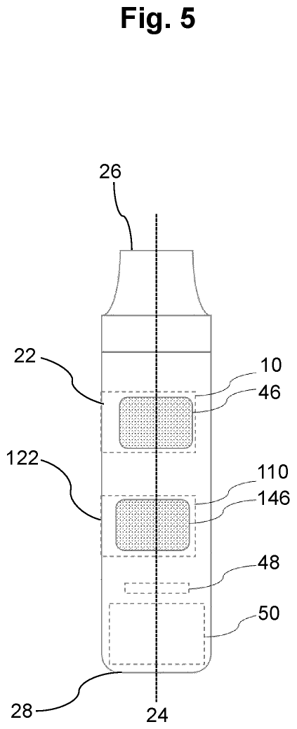

FIG. 5 shows an aerosol-generating system;

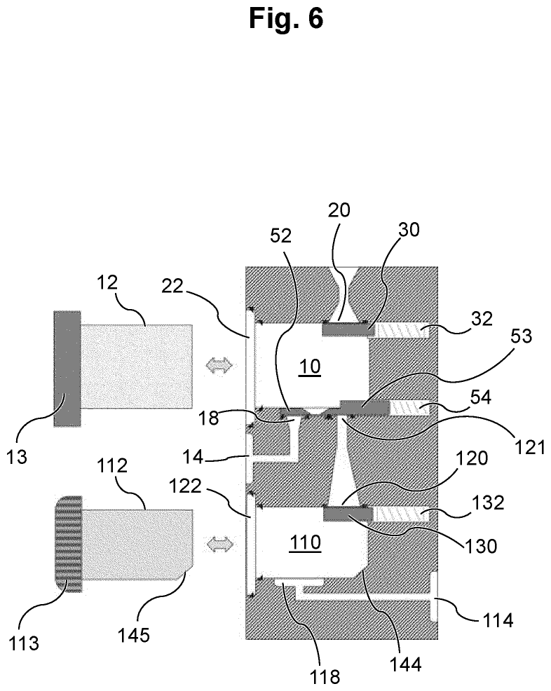

FIGS. 6 to 8 show part of the aerosol-generating system of FIG. 5; and

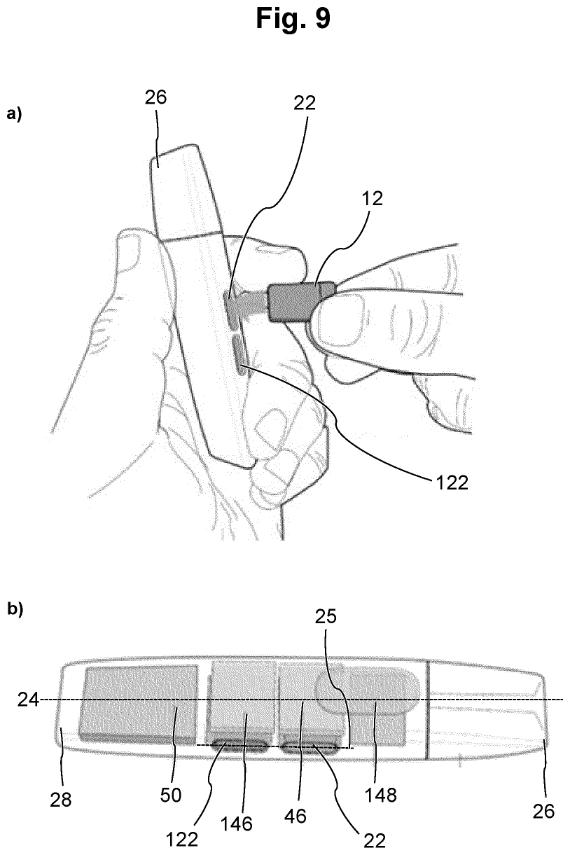

FIGS. 9a and 9b show an aerosol-generating device.

FIG. 1 shows an aerosol-generating system. The aerosol-generating system comprises and aerosol-generating device. The aerosol-generating device comprises a main cavity 10 arranged for receiving a main article 12. The main article 12 comprises a main aerosol-forming substrate. The aerosol-generating device comprises a main airflow channel extending from a main air inlet 14 to an air outlet 16 via the main cavity 10. The main airflow channel comprises a main inlet channel extending from the main air inlet 14 to a main cavity inlet 18. The main airflow channel comprises an air outlet channel extending from a main cavity outlet 20 to the air outlet 16.

The main cavity 10 comprises a main cavity opening 22 for insertion of the main article 12.

The aerosol-generating device comprises a main axis 24 extending between a proximal end 26 and a distal end 28 of the device. The main cavity opening 22 is arranged in a lateral sidewall of the device such that the main article 12 may be inserted into the main cavity 10 via the main cavity opening 22 along an insertion direction, the insertion direction being substantially perpendicular to the main axis 24. The proximal end 26 comprises a mouthpiece, for example a removable or disposable mouthpiece.

The aerosol-generating device of FIG. 1 comprises a main cavity outlet valve assembly as shown in FIGS. 2a and 2b.

FIGS. 2a and 2b shows the main cavity outlet valve assembly of an aerosol-generating device according to FIG. 1. The main cavity outlet valve assembly comprises a gate valve 30. The gate valve 30 is movable between a closed position shown in FIG. 2a and an open position shown in FIG. 2b. An airflow route through the device is indicated by dotted arrows in FIG. 2b.

In the closed position, the gate valve 30 is closing the main cavity outlet 20. In the open position, the main cavity 10 is fluidly connected to the air outlet 16.

The gate valve 30 of the main cavity outlet valve assembly is arranged in the main cavity 10. The gate valve 30 of the main cavity outlet valve assembly is configured for being pushed by the main article 12 from the closed position into the open position upon insertion of the main article 12 into the main cavity 10.

The main cavity outlet valve assembly comprises a compressible element 32 connected to the gate valve 30. The compressible element 32 may be a compressible spring.

The main cavity outlet valve assembly is configured such that the compressible element 32 is in a relaxed configuration when the gate valve 30 is in the closed position as shown in FIG. 2a. The aerosol-generating device may further comprise a main cavity inlet valve assembly as described herein.

The air outlet channel optionally comprises a venturi conduit. The venturi conduit comprises an intermediate section of the air outlet channel. The intermediate section has a reduced cross-sectional area 34 compared to sections of the air outlet channel upstream and downstream of the intermediate section.

The main cavity inlet 18 optionally comprises a distribution chamber. The distribution chamber comprises an enlarging cross-sectional area 36 of the main inlet channel in a direction towards the main cavity 10.

The aerosol-generating device may further comprise a main cavity inlet valve assembly comprising a gate valve 52 and a compressible element 54. This is shown in FIG. 3a. The gate valve 52 of the main cavity inlet valve assembly is movable between a closed position and an open position, wherein, in the closed position, the gate valve 52 is closing the main cavity inlet 18, and wherein, in the open position, the main cavity 10 is fluidly connected to the main air inlet 14. The gate valve 52 of the main cavity inlet valve assembly is arranged in the main cavity 10. The gate valve 52 of the main cavity inlet valve assembly and the gate valve 30 of the main cavity outlet valve assembly are configured for being both together pushed by the main article 12 from the closed position into the open position upon insertion of the main article 12 into the main cavity 10.

FIG. 3b shows an embodiment of an aerosol-generating system in accordance with FIG. 1. The embodiment of FIG. 3b differs from the embodiment of FIG. 3a in that the embodiment of FIG. 3b comprises only the main cavity inlet valve assembly and not the main cavity outlet valve assembly.

FIG. 4 shows a schematic representation of the main cavity 10 in perspective view. The main cavity 10 comprises first and second major boundary surfaces 38, 40. The first and second major boundary surfaces 38, 40 of the main cavity 10 extend in facing parallel relations and defining a principal flow axis 42 for fluid flowing through the main cavity 10 from the main cavity inlet 18 to the main cavity outlet 20.

The device may be configured such that fluid flow, in use, from the main cavity inlet 18 to the main cavity outlet 20 is in a direction substantially parallel to the principal flow axis 42. The principal flow axis 42 is substantially parallel to the main axis 24 of the aerosol-generating device.

An inner volume of the main cavity 10 has a generally cuboid shape. However, the main cavity 10 may comprise a geometric feature for inhibition of insertion of a wrong article into the main cavity 10. The geometric feature may be, for example, a cut-off corner 44.

A diameter “x” of the first and second major boundary surfaces 38, 40 is at least four times the length of a distance “y” between the first and second major boundary surfaces 38, 40 in a direction perpendicular to the principal flow axis 42.

The cavity shown in FIG. 4 may alternatively be an ancillary cavity as described herein.

FIG. 5 shows an aerosol-generating device comprising a main cavity 10 for receiving a main article 12 via a main cavity opening 22, and an ancillary cavity 110 for receiving an ancillary article 112 via an ancillary cavity opening 122. The aerosol-generating device comprises a main axis 24 extending between a proximal end 26 and a distal end 28 of the device. The proximal end 26 comprises a mouthpiece.

The aerosol-generating device comprises a main heating element 46 configured for heating the main article 12 received in the main cavity 10. The aerosol-generating device comprises an ancillary heating element 146 configured for heating the ancillary article 112 received in the ancillary cavity 110.

Each of the main and ancillary heating elements 46, 146 may comprise at least one planar inductor coil. The at least one inductor coil may be configured for heating a respective susceptor element. The respective susceptor element may be part of the aerosol-generating device, or may be part of the respective main article 12 or ancillary article 112.

The aerosol-generating device may comprise one or both of a controller 48 and a power source 50. The aerosol-generating device may be configured such that the main heating element 46 and the ancillary heating element 146 are independently controllable.

The aerosol-generating device of FIG. 5 comprises a main airflow channel, an ancillary airflow channel, a main cavity outlet valve assembly, a main cavity inlet valve assembly, and an ancillary cavity outlet valve assembly as shown in FIGS. 5 to 7.

The aerosol-generating device of FIG. 5 may comprise one or more additional cavities arranged upstream of the ancillary cavity and the main cavity. Each of the one or more additional cavities may comprise an additional airflow channel similar to the ancillary airflow channel. Each of the one or more additional cavities may comprise one or more additional valve assemblies similar to the valve assemblies of the main cavity and the ancillary cavity.

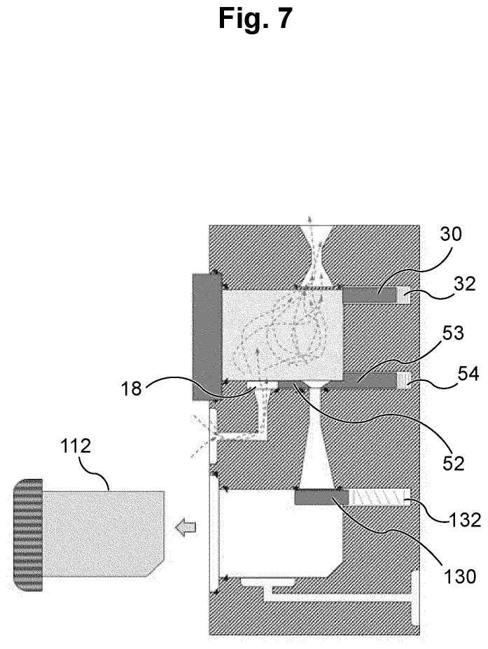

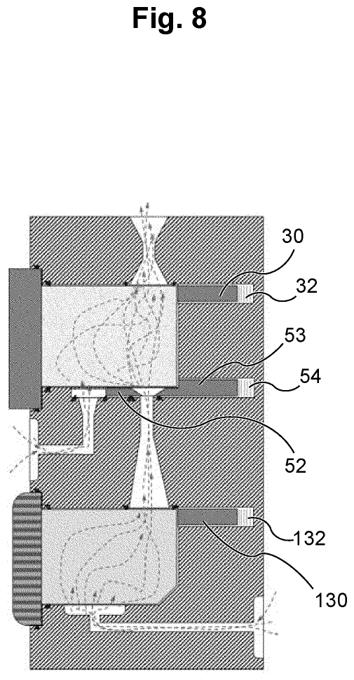

FIG. 6 shows the aerosol-generating device with both the main article 12 and the ancillary article 112 not being inserted into the device. FIG. 7 shows the aerosol-generating device with only the main article 12 being inserted into the main cavity 10 of the device. FIG. 8 shows the aerosol-generating device with both the main article 12 and the ancillary article 112 being inserted into the respective cavity 10, 110 of the device. An airflow route through the device is indicated by dotted arrows in FIGS. 6 and 7.

As shown in FIGS. 5 to 7, the aerosol-generating device comprises a main airflow channel extending from a main air inlet 14 to an air outlet 16 (see FIG. 5) via the main cavity 10. The main airflow channel comprises a main inlet channel extending from the main air inlet 14 to a main cavity inlet 18. The main airflow channel comprises an air outlet channel extending from a main cavity outlet 20 to the air outlet 16. The main cavity 10 comprises a main cavity opening 22 for insertion of the main article 12.

The aerosol-generating device comprises a main cavity outlet valve assembly comprising a gate valve 30 as described above in conjunction with the embodiment of FIGS. 2a and 2b. The aerosol-generating device further comprises a main cavity inlet valve assembly comprising a gate valve 52 arranged within the main cavity 10. The gate valve 52 of the main cavity inlet valve assembly is movable between a closed position and an open position, wherein, in the closed position, the gate valve 52 is closing the main cavity inlet 18, and wherein, in the open position, the main cavity 10 is fluidly connected to the main air inlet 14.

The gate valve 52 of the main cavity inlet valve assembly is configured for being pushed by the main article 12 from the closed position shown in FIG. 6 into the open position shown in FIGS. 6 and 7, upon insertion of the main article 12 into the main cavity 10. The gate valve 52 of the main cavity inlet valve assembly and the gate valve 30 of the main cavity outlet valve assembly are configured such that they are both pushed into their open positions by the main article 10. The main cavity inlet valve assembly comprises a compressible element 54 connected to the gate valve 52. The main cavity inlet valve assembly is configured such that the compressible element 54 is in a relaxed configuration when the gate valve 52 is in the closed position as shown in FIG. 6.

The ancillary cavity 110 is arranged upstream of the main cavity 10. The aerosol-generating device comprises an ancillary airflow channel extending from an ancillary air inlet 114 to the main cavity 10 via the ancillary cavity 110. The ancillary airflow channel comprises an ancillary inlet channel extending from the ancillary air inlet 114 to an ancillary cavity inlet 118. The ancillary cavity inlet 118 may comprise a distribution chamber. The distribution chamber may comprise an enlarging cross-sectional area of the ancillary inlet channel in a direction towards the ancillary cavity 110.

The ancillary airflow channel comprises a supply channel extending from an ancillary cavity outlet 120 to a supply inlet 121. In the embodiment shown, the supply inlet 121 is configured as a supply inlet 121 into the main cavity 10. Alternatively, the supply inlet may be configured as a supply inlet into the main inlet channel.

The main cavity inlet valve assembly comprises an additional valve part 53.

The additional valve part 53 of the main cavity inlet valve assembly is movable between a closed position and an open position, wherein, in the closed position, the additional valve part 53 is closing the supply inlet 121, and wherein, in the open position, the main cavity 10 is fluidly connected to the supply channel.

The additional valve part 53 is configured for being pushed by the main article 12 from the closed position into the open position upon insertion of the main article 12 into the main cavity 10. The gate valve 52 and the additional valve part 53 are formed as one piece. The gate valve 52 and the additional valve part 53 are pushed together from the closed position into the open position upon insertion of the main article 12 into the main cavity 10. The compressible element 54 is connected to the gate valve 52 of the main cavity inlet valve assembly via the additional valve part 53.

The aerosol-generating device comprises an ancillary cavity outlet valve assembly comprising a gate valve 130. The gate valve 130 of the ancillary cavity outlet valve assembly is movable between a closed position and an open position. In the closed position of the gate valve 130 of the ancillary cavity outlet valve assembly, the gate valve 130 is closing the ancillary cavity outlet 120. In the open position of the gate valve 130 of the ancillary cavity outlet valve assembly, the ancillary cavity 110 is fluidly connected to the supply channel.

The gate valve 130 of the ancillary cavity outlet valve assembly is arranged in the ancillary cavity 110. The gate valve 130 of the ancillary cavity outlet valve assembly is configured for being pushed by the ancillary article 112 from the closed position into the open position upon insertion of the ancillary article 112 into the ancillary cavity 110.

The ancillary cavity outlet valve assembly comprises a compressible element 132 connected to the gate valve 130. The ancillary cavity outlet valve assembly is configured such that the compressible element 132 is in a relaxed configuration when the gate valve 130 is in the closed position as shown in FIGS. 5 and 6.

The main cavity opening 22 and the ancillary cavity opening 122 are arranged in a lateral sidewall of the device such that the main article 12 may be inserted into the main cavity 10 via the main cavity opening 22 along an insertion direction, and the ancillary article 112 may be inserted into the ancillary cavity 110 via the ancillary cavity opening 122 along the insertion direction, the insertion direction being substantially perpendicular to the main axis 24.

The main article 12 comprises a cap element 13 configured to be grasped by a hand of a user. The cap element 13 may comprise a sealing element configured to seal the opening 22 of the main cavity 10 when the main article 12 is inserted into the main cavity 10.

The ancillary article 112 comprises a cap element 113 configured to be grasped by a hand of a user. The cap element 113 may comprise a sealing element configured to seal the opening 122 of the ancillary cavity 110 when the ancillary article 112 is inserted into the ancillary cavity 110.

The ancillary article 112 and the ancillary cavity 110 comprise corresponding geometric features. The corresponding geometric features may be, for example, a cut-off corner 144 of the ancillary cavity 110 and a corresponding cut-off corner 145 of the ancillary article 112. By the corresponding geometric features, insertion of a wrong article, for example insertion of the main article 12 into the ancillary cavity 110, may be prevented using the key-lock principle

FIGS. 9a and 9b show an aerosol-generating device in perspective views. The device may be the device of FIG. 5. A proximal end 26 of the device is configured as a mouthpiece. The mouthpiece may be replaceable.

The device of FIGS. 9a and 9b may be described as a “side loader”. The main cavity opening 22 and the ancillary cavity opening 122 are provided in a lateral side wall of the device. The housing of the device comprises two large opposing major surfaces and two smaller opposing minor surfaces. The main cavity opening 22 and the ancillary cavity opening 122 are arranged in one of the minor surfaces.

Both of the main cavity opening 22 and the ancillary cavity opening 122 have a planar slot-like shape for insertion of a card-like shaped article 12, 112. Both the main cavity opening 22 and the ancillary cavity opening 122 are formed as slots, each slot having a longitudinal axis of extension, wherein both axes are parallel to each other and are aligned forming a common longitudinal axis 25 of the cavity openings 22, 122. The common longitudinal axis 25 of the cavity openings 22, 122 is arranged substantially collinear with the longitudinal axis 24 of the device, the longitudinal axis 24 of the aerosol-generating device extending between the proximal end 26 and the distal end 28 of the device.

FIG. 9a shows hands of a user, illustrating a user conveniently inserting a main article 12 into the main cavity 10 via the main cavity opening 22.

One or both of the main cavity 10 and the ancillary cavity 110 may comprise a tray mechanism for insertion and ejection of the respective article 10, 110. For example, the tray mechanism may comprise an insertable tray for receiving the respective article 12, 112, the insertable tray being configured for being insertable into the respective cavity 10, 110. For example, the tray mechanism may comprise a slidable tray for receiving the respective article 12, 112. The slidable tray may be slidable into and out of the respective cavity 10, 110. The mechanism may be similar to a slidable tray mechanism known for CD players.

One or both of the main cavity 10 and the ancillary cavity 110 may comprise a push-pull insertion and ejection mechanism for insertion and ejection of the respective article 10, 110. Preferably, one or both of the main cavity 10 and the ancillary cavity 110 comprise a push-push insertion and ejection mechanism for insertion and ejection of the respective article 10, 110. The push-push insertion and ejection mechanism may be similar to the mechanism used for SD cards or SIM cards, for example the Molex push-push ejection system for SD/SIM (push-to-insert, push-to-eject). The respective cavity 10, 110 may comprise a socket for removably holding a card-like article 12, 112. The insertion and ejection mechanism may be arranged not to interfere with any of the valve mechanisms as described herein, when considering an embodiment wherein one or more valve assemblies are present.

In FIG. 9b, walls of the outer housing of the device are shown in transparent for illustrative purposes, such that inner components of the device are made visible. The aerosol-generating device comprises a power source 50, preferably in form of a pouch battery. The aerosol-generating device comprises a main heating element 46 configured for heating the main article 12 received in the main cavity 10 via the main cavity opening 22. The aerosol-generating device comprises an ancillary heating element 146 configured for heating the ancillary article 112 received in the ancillary cavity 110 via the ancillary cavity opening 122. The main and ancillary heating elements 46, 146 are configured as flat or planar heating elements. The main and ancillary heating elements 46, 146 may, for example be configured as resistive heating elements, or as inductive heating elements each comprising a planar inductor coil.

1.-15. (canceled)

16. An aerosol-generating device, comprising:
a main cavity arranged to receive a main article having a main aerosol-forming substrate;
a main airflow channel extending from a main air inlet to an air outlet via the main cavity, the main airflow channel comprising a main inlet channel extending from the main air inlet to a main cavity inlet, and an air outlet channel extending from a main cavity outlet to the air outlet; and
one or both of:
a main cavity outlet valve assembly comprising a gate valve, the gate valve being movable between a closed position and an open position, wherein, in the closed position, the gate valve is closing the main cavity outlet, wherein, in the open position, the main cavity is fluidly connected to the air outlet, and wherein the gate valve of the main cavity outlet valve assembly is configured to be pushed by the main article from the closed position into the open position upon insertion of the main article into the main cavity, and
a main cavity inlet valve assembly comprising a gate valve, the gate valve being movable between a closed position and an open position,
wherein, in the closed position, the gate valve is closing the main cavity inlet, wherein, in the open position, the main cavity is fluidly connected to the main air inlet, and wherein the gate valve of the main cavity inlet valve assembly is configured to be pushed by the main article from the closed position into the open position upon insertion of the main article into the main cavity.

17. The aerosol-generating device according to claim 16, wherein one or both of
the aerosol-generating device further comprises the main cavity outlet valve assembly and the gate valve of the main cavity outlet valve assembly is arranged in the main cavity, and
the aerosol-generating device further comprises the main cavity inlet valve assembly and the gate valve of the main cavity inlet valve assembly is arranged in the main cavity.

18. The aerosol-generating device according to claim 16, further comprising the main cavity outlet valve assembly.

19. The aerosol-generating device according to claim 16, further comprising the main cavity inlet valve assembly.

20. The aerosol-generating device according to claim 16, further comprising both the main cavity inlet valve assembly and the main cavity outlet valve assembly, such that the gate valve of the main cavity inlet valve assembly and the gate valve of the main cavity outlet valve assembly are both configured to be pushed by the main article.

21. The aerosol-generating device according to claim 16,
wherein the main cavity comprises a main cavity opening configured for insertion of the main article,
wherein the aerosol-generating device further comprises a main axis extending between a proximal end and a distal end of the device, and
wherein the main cavity opening is arranged in a lateral sidewall of the device such that the main article may be inserted into the main cavity via the main cavity opening along an insertion direction, the insertion direction being substantially perpendicular to the main axis.

22. The aerosol-generating device according to claim 21, wherein the proximal end comprises a mouthpiece.

23. The aerosol-generating device according to claim 16, further comprising:
an ancillary cavity arranged upstream of the main cavity configured to receive an ancillary article having an ancillary aerosol-forming substrate; and
an ancillary airflow channel extending from an ancillary air inlet to the main cavity via the ancillary cavity, the ancillary airflow channel comprising an ancillary inlet channel extending from the ancillary air inlet to an ancillary cavity inlet, and a supply channel extending from an ancillary cavity outlet to a supply inlet, wherein the supply inlet is configured as a supply inlet into the main inlet channel, or as a supply inlet into the main cavity

24. The aerosol-generating device according to claim 23,
further comprising an ancillary cavity outlet valve assembly comprising another gate valve, the another gate valve being movable between a closed position and an open position,
wherein, in the closed position, the another gate valve is closing the ancillary cavity outlet, and
wherein, in the open position, the ancillary cavity is fluidly connected to the supply channel.

25. The aerosol-generating device according to claim 24, wherein the another gate valve of the ancillary cavity outlet valve assembly is configured to be pushed by the ancillary article from the closed position into the open position upon insertion of the ancillary article into the ancillary cavity.

26. The aerosol-generating device according to claim 23,
further comprising an ancillary cavity inlet valve assembly comprising another gate valve, the another gate valve being movable between a closed position and an open position,
wherein, in the closed position, the another gate valve is sealing the ancillary cavity inlet, and
wherein, in the open position, the ancillary cavity is fluidly connected to the ancillary air inlet.

27. The aerosol-generating device according to claim 23,
further comprising a main heating element configured to heat the main article received in the main cavity and an ancillary heating element configured to heat the ancillary article received in the ancillary cavity, and
wherein the aerosol-generating device is configured such that the main heating element and the ancillary heating element are independently controllable.

28. The aerosol-generating device according to claim 27, wherein the each of the main heating element and the ancillary heating element comprises at least one inductor coil.

29. The aerosol-generating device according to claim 27, wherein the each of the main heating element and the ancillary heating element comprises at least one planar inductor coil.

30. The aerosol-generating device according to claim 23, wherein the main cavity and the ancillary cavity are differently shaped to avoid insertion of a wrong article following a key-lock principle.

31. The aerosol-generating device according to claim 23,
wherein the ancillary cavity comprises first and second major boundary surfaces, the first and the second major boundary surfaces of the ancillary cavity extending in facing parallel relations and defining a principal flow axis configured for fluid flow through the ancillary cavity, and
wherein the aerosol-generating device is configured such that fluid flow from the ancillary cavity inlet to the ancillary cavity outlet is in a direction substantially parallel to the principal flow axis.

32. The aerosol-generating device according to claim 16,
wherein the main cavity comprises first and second major boundary surfaces, the first and the second major boundary surfaces of the main cavity extending in facing parallel relations and defining a principal flow axis configured for fluid flow through the main cavity, and
wherein the aerosol-generating device is configured such that fluid flow from the main cavity inlet to the main cavity outlet is in a direction substantially parallel to the principal flow axis.

33. An aerosol-generating system comprising the aerosol-generating device according to claim 16 and a main article comprising a main aerosol-forming substrate.

34. The aerosol-generating system according to claim 33, wherein the main article is shaped to closely conform to a shape of the main cavity.
